(19) United States
(12) Patent Application Publication
(10) Pub. No.: US 2009/0104431 A1
(43) Pub. Date: Apr. 23, 2009

(54) Coated paper for printing

(76) Inventors: Takayuki Kishida, Hyogo (JP); Yuichi Ogawa, Hyogo (JP); Kenji Yanagisawa, Hyogo (JP); Hideaki Yamada, Hyogo (JP); Yoshiki Kojima, Hyogo (JP); Tetsuya Hirabayashi, Hyogo (JP)

Correspondence Address: Striker, Striker & Stenby, 103 East Neck Road, Huntington, NY, 11743, US

(21) Appl. No.: 10/576,115

(22) PCT Filed: Jan. 25, 2005
(86) PCT No.: PCT/JP2005/000916

§ 371 Date: Apr. 18, 2006

(30) Foreign Application Priority Data
Jan. 26, 2004 (JP) 2004-016459

(51) Int. Cl. B32B 5/16; B29C 43/24

(52) U.S. Cl. 428/323; 264/175

(57) ABSTRACT

A coated paper for printing having a bulk density of 1.05 g/cm³ or less and two or more coating layers mainly composed of white pigments and adhesives formed on at least one side of a base paper which has a bulk density of 0.75 g/cm³ or less, wherein pigments of an undercoat in contact with an outermost coating layer comprises satin white of 1-30 mass % whose average particle diameter is within a range of 0.1-1.3 μm measured pursuant to radiolucent particle size distribution measurement and other white pigments of 70-99 mass %, wherein an amount of the adhesives of the undercoat is within a range of 10-20 mass % based on 100 mass parts of pigment components.

### FIELD OF THE INVENTION

The present invention relates to a bulky coated paper for printing with improved smoothness.

### BACKGROUND OF THE INVENTION

In general, a coated paper for printing is prepared by applying coating solution mainly composed of pigments and adhesives onto at least one side of raw paper, and by drying it. Such a coated paper for printing is classified into, for example, a cast-coat paper, an art paper, a coated paper, or a slight coated paper in accordance with the application volume of coating solution, or the finishing process of a coated paper. Those coated papers applied with polychromatic or monochromatic printing processes have been widely used for commercial printed matter such as advertising leaflets, pamphlets, or posters, or for publications such as books or magazines.

In recent years, a trend toward visualization and colorization of printed matter is in progress, which has increased demand for a high quality coated paper for printing. Specifically, glossiness, smoothness, and brightness of a coated paper for printing will determine the quality of the print.

An addition of satin white in a coating layer has been proposed as one technique for improving the smoothness of a coated paper for printing (Patent References 1˜4). Satin white is a white pigment of needle crystal produced by, for instance, the reaction of calcium hydroxide and aluminum sulfate, and its standard nomenclature is calcium trisullfoaluminate. Satin white is an inorganic complex compound represented with the following formula (I), and the surface of a coating layer containing this compound generally provides an excellent smoothness.

3CaO.Al₂O₃.3CaSO₄.31˜32H₂O (1)

However, all the prior art teaches only that satin white may be contained in a coating layer of a coated paper to receive ink. In a conventional coated paper for printing, one or more undercoat may be provided under a coating layer that is operable for receiving ink (hereinafter referred to as an outermost coating layer). In most cases, an undercoat is provided to improve the smoothness of the outermost coating layer. However, prior arts have disregarded an effect on the smoothness of the outermost coating layer that is caused by said undercoat. Although there are a few examples in which satin white is used in pigmented undercoating in conventional coating papers for printing (see patent document 5), in most cases, relatively inexpensive pigments and adhesives such as starch have been used.

However, it is commonly seen that if an undercoat is used, its surface smoothness influences the smoothness of the outermost coating layer (ink receiving layer) provided on an undercoat. The smoothness of an outermost coating layer operable to receive ink determines the glossiness of the layer. Thereby, not only the outermost coating layer (ink receiving layer) but also the composition of the undercoat plays a key role in obtaining a coated paper for printing excellent in glossiness, smoothness, and brightness.

In addition to a demand for excellent glossiness, smoothness, and whiteness for a coated paper for printing, recently, the feel or touch of a paper and an apparent specific volume have increasingly attracted attention. In particular, in those days, a bulky coated paper is highly appreciated for use in publication.

In order to increase the bulk of a coated paper for printing, several approaches are proposed. For example, the bulk of a base paper is increased by the addition of bulking promoter (see patent documents 6-7), by processing a coating layer applied on a base paper with thermo-soft-calendering or the like (see patent documents 8-10), or by using hollow plastic pigments in a coating layer (see patent documents 11-12).

In other words, a conventional proposal for obtaining bulkiness employs a relatively bulky base paper as well as reduced pressure applied to a base paper or a coating layer during the calendering process of a coated paper obtained by applying coating liquid on a base paper. However, reduction of the pressure during the calendering process will lessen the smoothing effect of a calendering processed coating layer compared with normal pressure.

Therefore, in order to obtain a bulky coated paper excellent in smoothness, that is, the smoothness of the outermost coating layer, it is important for the outermost coating layer to maintain smoothness before the calendering process.

With regard to a mild calendering process, as explained previously, one prior art document discloses the use of a white pigment (for instance, satin white), whose crystal is a needle form or a flat plate, to obtain a coated paper excellent in smoothness. Alternatively, an approach is proposed in which the bulk of an outermost coating layer is increased to camouflage a rough surface which comes in contact with the outermost coating surface.

However, because a coated paper has a predetermined base weight, not only is it impossible to increase the thickness of an outermost coating layer so much, but also increasing the thickness of an outermost coating layer inevitably elevates the bulk density of a coated paper. Thereby, it is difficult to obtain a bulky coated paper when the former approach is employed.

The bulk density of an ordinary coated paper for printing, which is not categorized as “bulky”, is normally within a range of 1.15-1.25 g/cm³. Therefore, “a bulky coated paper for printing” described in this specification indicates a coated paper whose bulk density is 10.10 g/cm³ or less, typically, not higher than 1.05/cm³. The measurement of bulk density was carried out pursuant to ISO 534:1988.

Patent Document 1: Unexamined Patent Publication No. H11-247097

Patent Document 2: Unexamined Patent Publication No. H09-256295

Patent Document 3: Unexamined Patent Publication No. H09-67794

Patent Document 4: Unexamined Patent Publication No. H02-14098

Patent Document 5: Unexamined Patent Publication No. H07-238495

Patent Document 6: Unexamined Patent Publication No. 2002-155494

Patent Document 7: Unexamined Patent Publication No. 2003-171893

Patent Document 8: Patent Publication No. 3249212

Patent Document 9: Unexamined Patent Publication No. H09-228298

Patent Document 10: Unexamined Patent Publication No. H06-294100

Patent Document 11: Unexamined Patent Publication No. 2002-220795

Patent Document 12: Unexamined Patent Publication No. H09-119090

### SUMMARY OF THE INVENTION

The present invention provides a bulky coated paper for printing that has two or more coating layers mainly composed of white pigments and adhesives provided on, at least, one surface of a base paper, wherein the coated paper has a bulk density of 1.05 g/cm³ or less and is excellent in smoothness.

Therefore, according to the invention, there is provided a coated paper for printing having a bulk density of 1.05 g/cm³ or less and two or more coating layers mainly composed of white pigments and adhesives formed on, at least, one side of a base paper which has a bulk density of 0.75 g/cm³ or less, wherein pigments of an undercoat being in contact with an outermost coating layer comprises satin white of 1-30 mass % whose average particle diameter is within a range of 0.1-1.3 μm measured pursuant to radiolucent particle size distribution measurement, and other white pigments of 70-99 mass %, wherein an amount of the adhesives of the undercoat is within a range of 10-20 mass % based on 100 mass parts of pigment components.

With regard to adhesive components of an undercoat, it is preferable to use dispersant type adhesives in which each dispersant particle has a diameter of 120 nm or less, more preferably, not greater than 100 nm. When water soluble adhesives are used together, it is preferable to use 7 mass parts or less water soluble adhesives based on 100 parts of pigment components.

In a coated paper for printing having two coating layers mainly composed of pigments and adhesives on at least one side of a base paper, an undercoat in contact with an outermost coating layer corresponds to an undercoat according to prior arts, as mentioned previously. Therefore, an undercoat in contact with an outermost coating layer may be called an “undercoat” in this description. Furthermore, as an average particle diameter was measured pursuant to radiolucent particle size distribution measurement, an average particle diameter regarding pigment components referred to hereinafter means an average particle diameter pursuant to radiolucent particle size distribution measurement.

A coated paper for printing of the invention preferably comprises an outermost coating layer whose pigment components contain white pigments wherein an average particle diameter of the pigments is within a range of 0.1-1.3 μm, and wherein the amount of adhesives in the outermost layer is within a range of 10-20 mass parts based on 100 mass parts of pigment components of the outermost layer.

Pigment components of an outermost coating layer preferably contain satin white of 1-30 mass % of the total amount of the pigment components.

It is preferable to use dispersant particles having a diameter of 120 nm or less, more preferably, not greater than 100 nm for adhesive components of an outermost coating layer. When water soluble adhesives are used together, it is preferable to use 4 mass parts or less water soluble adhesives based on 100 mass parts of pigment components.

The manufacturing method of the invention of a coated paper for printing of the invention comprises a step of: applying a first coating mixture containing pigment components composed of satin white having an average diameter of 0.1-1.3 μm in an amount of 1-30 mass % and other white pigments in an amount of 70-99 mass %, and adhesives in an amount of 10-20 mass parts based on 100 mass parts of pigment components on at least one surface of a base paper whose bulk density is 0.75 g/cm³ or less to dry to make an undercoat; applying a second coating mixture containing pigment components having an average diameter of 0.1-1.3 μm and adhesives in an amount of 10-20 mass parts based on 100 mass parts of pigment components on a surface of the undercoat to dry to form an outermost coating layer; and calender-processing of the thus obtained coated paper under mild conditions.

In the above manufacturing method, a total amount of the first and second coating mixture is preferably within a range of 10-20 g/m² per one surface of a base paper. The PPS smoothness of an undercoat on which the second coating mixture is applied is preferably within a range of 2.0-3.5 μm.

A coated paper for printing of the invention is bulky as it has a bulk density of 1.05 g/cm³ or less and is excellent in smoothness, which results in a good appearance after the printing process is completed.

### BEST MODE FOR CARRYING OUT THE INVENTION

Generally speaking, a coated paper for printing is produced by forming one or more coating layers mainly composed of white materials and adhesives on at least one surface of a base paper. As it is an object of the present invention to provide a coated paper whose bulk density is 1.05 g/cm³ or less, it is a sole condition for a base paper to have a bulk density of 0.75 g/cm³ or less. As long as this condition is met, no other condition, such as types of material pulps or any other conditions for making a base paper, is required. In addition, it does not matter whether a base paper is size-pressed or not.

A coated paper of the invention is produced by forming an undercoat on at least one surface of a base paper of which the bulk density is 0.75 g/cm³ or less and adding an outermost coating layer subsequently. The main components of both the undercoat and outermost layers are pigment components and adhesives.

For pigment components of an undercoat used in a coated paper of the invention, whatever kind is used, the average diameter of a particle should be within a range of 0.1-1.3 μm, preferably, 0.3-1.0 μm. When an average particle diameter of pigment component constituting an undercoat exceeds 1.3 μm, it is difficult to provide such an undercoat with excellent smoothness. On the other hand, when an average particle diameter of pigment component is less than 0.1 μm, although it is easy to attain smoothness, it requires a relatively large amount of adhesives to make an undercoat, which is economically disadvantageous.

Pigment components of an undercoat contain white satin of 1-30 mass %, preferably, 3-20 mass % of the total amount of the pigment components. We found that it was preferable to contain satin white in an undercoat, and in addition to specify an average particle diameter of pigment component as mentioned above in order to provide an undercoat with an excellent smoothness. When the amount of satin white is less than 1 mass % of pigment components of an undercoat, it is difficult to provide such an undercoat with excellent smoothness. On the other hand, when the amount of satin white exceeds 30 mass % of pigment components of an undercoat, although the smoothness of the undercoat improves, it requires a relatively large amount of adhesives in making the undercoat, which is also economically disadvantageous.

The following is an example of white pigments that may be used with satin white as pigment components of an undercoat: inorganic pigments such as calcium carbonate, kaolin, calcined kaolin, structured kaolin, delaminated kaolin, talc, calcium sulfate, barium sulfate, aluminum hydroxide, titanium dioxide, zinc oxide, alumina, magnesium carbonate, magnesium oxide, silica, alminosilicate magnesium, calcium silicate bentonite, zeolite, sericite, or smectite, and plastic pigments such as solid type, hollow type, or through-hole type. One or more of those pigments can be used with satin white.

Normally, dispersant type adhesives are used for adhesive components of an undercoat. An example of dispersant type adhesives includes conjugated diene type polymer latex such as styrene-butadien copolymer or methyl methacrylate-butadien copolymer, acrylic polymer latex, and vinyl type polymer latex such as ethylene-vinyl acetate copolymer. Although one or more adhesives can be used, whichever adhesive is used, the particle diameter of dispersant adhesive particles should be 120 nm or less, preferably not greater than 100 nm.

A small amount of water soluble adhesives can be used with the aforementioned dispersant type adhesives. An example of such water soluble adhesives includes a variety of starches such as starch oxide, esterified starch, or cold water soluble starch, proteins such as casein, soybean albumin, or synthetic protein, cellulose derivatives such as carboxymethyl cellulose, or methyl cellulose, polyvinyl alcohol, and its denatured products.

The amount of adhesives contained in an undercoat may be selected from a range of 10-20 mass parts, in particular, from a range of 1-18 mass parts based on 100 mass parts of pigment components contained in an undercoat no matter whether a water soluble adhesive is used together or not. When an amount of adhesives contained in an undercoat is less than 10 mass parts, the binding power may not be sufficient. On the other hand, when an amount of adhesives exceeds 20 mass parts, the smoothness of the undercoat will be reduced.

When a water soluble adhesive is used together, its amount should be 7 mass parts or less, preferably not greater than 4 mass parts based on 100 mass parts of pigment components. When it exceeds 7 mass parts, the smoothness of an undercoat will be reduced, and is, therefore, disadvantageous. To use a small amount of water soluble adhesives together with dispersant type adhesives improves viscosity and water retentivity of the coating mixture forming an undercoat.

The undercoat of a coated paper for printing of the invention is formed by applying a first coating mixture containing pigment components composed of satin white in an amount of 1-30 mass % and other white pigments in an amount of 70-99 mass %, of which the average particle diameter is within a range of 0.1-1.3 μm, respectively, and adhesives in an amount of 10-20 mass parts based on 100 mass parts of pigment components on one or both surfaces of a base paper and drying it. For coating application, although various methods such as roll coating, air knife coating, bar coating, or blade coating can be employed, blade coating is preferable. A first coating mixture is followed with a second coating mixture for forming an outermost coating layer which will be explained later, selected from a range of 10-20 g/m² per one surface of a base paper.

PPS smoothness of an undercoat obtained from a first coating mixture will be adjusted to a range of 2.0-3.5 μm, preferably a range of 2.6-3.2 μm. PPS smoothness of an undercoat obtained by applying a first coating mixture composed as above on a base paper by blade coating is normally within the aforementioned range.

Needless to say, when an outermost coating layer is formed by blade coating using a second coating mixture which will be explained later, if PPS smoothness of the undercoat is less than 2.0 μm, there is a risk that a streak or scratch will occur in the outermost coating layer. However, when PPS smoothness of the undercoat is 2.6 μm or greater, streaks or scratches can be completely prevented.

An outermost coating layer of a coated paper for printing according to the invention is formed by applying a second coating mixture containing white pigments having an average particle diameter of 0.1-1.3 μm, preferably 0.3-10 μm, and adhesives in an amount of 10-20 mass parts based on 100 mass parts of white pigments on the surface of an undercoat formed on a base paper and drying it. For coating application, although various methods such as roll coating, air knife coating, bar coating, or blade coating can be employed, blade coating is preferable. A second coating mixture is summed up with a first coating mixture for forming said undercoat to be selected from a range of 10-20 g/m² per one surface of a base paper.

The reason an average particle diameter of white pigments contained in an outermost coating layer is specified is substantially the same as the reason for an undercoat. It is preferable for white pigment, which is one of the primary components of an outermost coating layer, to contain satin white in an amount of 1-30 mass %, more preferably, 3-20 mass % of the total amount. The reason for this is practically the same as the reason for the undercoat explained above.

Other than satin white, pigment that may be used for an outermost coating layer include, for instance, inorganic pigments such as calcium carbonate, calcined kaolin, structured kaolin, delaminated kaolin, talc, calcium sulfate, barium sulfate, aluminum hydroxide, titanium dioxide, zinc oxide, alumina, magnesium carbonate, magnesium oxide, silica, alminosilicate magnesium, calcium silicate bentonite, zeolite, sericite, or smectite, and plastic pigments such as solid type, hollow type, or through-hole type. One or more of those white pigments can be used in this invention.

Similar to the undercoat described above, dispersant type adhesives are normally used for adhesive components of an outermost coating layer. An example of dispersant type adhesives includes conjugated diene type polymer latex such as styrene-butadien copolymer or methyl methacrylate-butadien copolymer, acrylic polymer latex, and vinyl type polymer latex such as ethylene-vinyl acetate copolymer. One or more adhesives can be used as adhesive components of an outermost layer.

It is preferable for the aforementioned dispersant adhesives used in an outermost coating layer to contain acrylonitrile of 10-35 mass % as a monomer of polymerization, in particular, 20-30 mass %. If acrylonitrile content in dispersant adhesives is less than 10 mass %, the absorbency of ink solvent cannot be lowered satisfactorily, which may damage printing glossiness. On the other hand, if acrylonitrile content in dispersant adhesives exceeds 35 mass %, it is difficult for emulsion polymerization to occur, which results in deficient binding power.

Whatever kind of dispersant adhesive is used in an outermost coating layer, the particle diameter of adhesive particles should be in a range of 50-120 nm, in particular, within a range of 50-90 nm is preferable.

A small amount of water soluble adhesives can be used with the aforementioned dispersant type adhesives. An example of such water soluble adhesives includes a variety of starches such as starch oxide, esterified starch, or cold water soluble starch, proteins such as casein, soybean albumin, or synthetic protein, cellulose derivatives such as carboxymethyl cellulose, or methyl cellulose, polyvinyl alcohol, and its denatured products.

The amount of adhesives contained in an outermost coating layer may be selected from a range of 10-20 mass parts, in particular, from a range of 1-18 mass parts based on 100 mass parts of pigment components contained in an outermost coating layer whether a water soluble adhesive is used together or not. When the amount of adhesives contained in an outermost coating layer is less than 10 mass parts, the binding power may not be sufficient. On the other hand, when the amount of adhesives exceeds 20 mass parts, the smoothness of an outermost coating layer will be reduced.

When a water soluble adhesive is used, its amount should be 4 mass parts or less based on 100 mass parts of pigment components. When it exceeds 4 mass parts, the smoothness of an outermost coating layer will be reduced, and such a level is therefore disadvantageous. To use a small amount of water soluble adhesives together with dispersant type adhesives improves viscosity and water retentivity of a coating mixture, forming an outermost coating layer.

A variety of auxiliaries such as blue system dyes or purple system dyes, color pigments, fluorescent dyes, viscosity water retention agents, antioxidants, age resistors, conductive inducible agents, antifoaming agents, ultraviolet absorbing agents, dispersants, pH controlling agents, mold releasing agents, waterproof agents, and water-repellent agents can be suitably combined and used in a first coating mixture constituting an undercoat and in a second coating mixture constituting an outermost coating layer.

A finishing process is applied to a coated paper through which a second coating mixture is added. Although various methods such as super calender, gloss calender, and soft calender can be used, a calender process employing a hard resin roll may be preferable.

In this invention, the average particle diameter of pigment components contained in an undercoat layer and an outermost coating layer is specified, respectively. In addition to this, because such an undercoat and an outermost layer are provided on either or both sides of a base paper having relatively low bulk density, a coated paper for printing having a bulk density of 1.05 g/cm³ or less can be obtained through a calender finish widely used in the field to which the invention pertains except for the case when a calender having especially high pressure is employed.

### EXAMPLES

Although the present invention will be explained below in detail by way of examples, it is not intended to limit the invention to those scopes.

The “parts” and “%” shown in examples indicate “parts by mass” and “mass %” unless otherwise specified. Furthermore, the average particle diameter of pigments and that of copolymer latex which is a dispersant adhesive, are measured pursuant to the following method.

### Average Particle Diameter of Pigments

Distributed processing was performed on pigments in liquid of 0.1% sodium pyrophosphate for five minutes by ultrasonic wave, which was then measured by a sedimentation method using radiolucent particle size distribution measuring equipment (type of machine: SediGgraph 5100, Micromeritics®). A particle diameter at the point where an accumulated mass from a coarse particle corresponds to 50% is shown as an average particle diameter.

### Average Particle Diameter of Copolymer Latex

A picture of samples containing copolymer latex was taken by a transmission electron microscope with a magnification ×50000. A particle diameter of approximately 200 copolymer latex was measured from the thus obtained pictures so as to calculate the average.

### Example 1

### Preparation of First Coating Mixture

To a pigment slurry consisting of 90% of ground calcium carbonate having an average particle diameter of 1.3 μm (trade name: Hydrocarb 60. Bihoku Funka Kogyo Co., Ltd.) and 10% of satin white having an average particle diameter of 1.0 μm (trade name: Satin White B, Shiraishi Kogyo Kaisha, Ltd.), two parts of Oxidized starch (trade name: Oji Ace B, Oji Cornstarch Co., Ltd.) and ten parts of styrene-butadien copolymer latex (trade name: SMARTEX PA2182-2, Average particle diameter: 100 nm, Nippon A & L, Inc.) were added based on 100 parts of pigments (in terms of solid matter). Then, as auxiliaries to the pigment slurry, antifoaming agents and dyes were added to prepare a first coating mixture to have a solid concentration of 59%.

### Preparation of Second Coating Mixture

To a pigment slurry consisting of 80% of fine kaolin having an average particle diameter of 0.4 μm (trade name: Kaogloss, Huber Inc., U.S.A.) and 20% of ground calcium carbonate having an average particle diameter of 0.8 μm (trade name: Hydrocarb 90, Bihoku Funka Kogyo Co., Ltd.), two parts of Oxidized starch (trade name: Oji Ace B, Oji Cornstarch Co., Ltd.) and twelve parts of styrene-butadien copolymer latex (trade name: SMARTEX PA2323, Acrylonitrile monomer content: 21 mass %, Average particle diameter: 89 nm, Nippon A & L, Inc.) were added based on 100 parts of pigments (in terms of solid matter). Then, as auxiliaries to the pigment slurry, antifoaming agents and dyes were added to prepare a second coating mixture to have a solid concentration of 59%.

Preparation of Coated Paper for Printing The aforementioned first coating mixture was applied to both sides of a fine quality base paper having a bulk density of 0.73 g/cm³ (basis weight: 72.5 g/m²) by a blade coater and dried to form an undercoat. The coating amount of the mixture was 8 g/m² per side surface after the coated material was dried. Next, the aforementioned second coating mixture was applied to the undercoat by a blade coater and dried to form an outermost coating layer. The coating amount of the mixture was 9 g/m² per side surface after the coated material was dried. The thus obtained coated paper was passed through a supercalender at a temperature of 35° C. and with a linear load of 80 KN/m to produce a sheet of coated paper for printing having a bulk density of 1.04 g/cm³.

### Example 2

Example 1 was repeated to produce a sheet of coated paper except that the pigment components of the second coating mixture used in example 1 were replaced by those consisting of 80% of fine kaolin having an average particle diameter of 0.4 μm (trade name: Kaogloss, Huber Inc. U.S.A.), 10% of ground calcium carbonate having an average particle diameter of 0.8 μm (trade name: Hydrocarb 90, Bihoku Funka Kogyo Co., Ltd.), and 10% of satin white having an average particle diameter of 1.0 μm (trade name: Satin White B, Shiraishi Kogyo Kaisha, Ltd.).

### Example 3

Example 2 was repeated to produce a sheet of coated paper except that the adhesive components of the first coating mixture used in example 2 were replaced by those consisting of six parts of oxidized starch (trade name: Oji Ace B, Oji Cornstarch Co., Ltd.) and eight parts of styrene-butadien copolymer latex (trade name: SMARTEX PA2182-2, Nippon A & L, Inc.) (in terms of solid matter) to have a solid concentration of 56%.

### Example 4

Example 2 was repeated to produce a sheet of coated paper except that the adhesive components of the first coating mixture used in example 2 were replaced by those consisting of 0.1 parts of oxidized starch and 11 parts of styrene-butadien copolymer latex (in terms of solid matter).

### Example 5

Example 2 was repeated to produce a sheet of coated paper except that the pigment components of the first coating mixture used in example 2 were replaced by those consisting of 70% of ground calcium carbonate having an average particle diameter of 1.3 μm (trade name: Hydrocarb 60, Bihoku Funka Kogyo Co., Ltd.) and 30% of satin white having an average particle diameter of 1.0 μm (trade name: Satin White B, Shiraishi Kogyo Kaisha, Ltd.) to have a solid concentration of 48%.

### Example 6

Example 2 was repeated to produce a sheet of coated paper except that the pigment components of the first coating mixture used in example 2 were replaced by those consisting of 90% of ground calcium carbonate having an average particle diameter of 0.8 μm (trade name: Hydrocarb 90, Bihoku Funka Kogyo Co., Ltd.) and 10% of satin white having an average particle diameter of 1.0 μm (trade name: Satin White B, Shiraishi Kogyo Kaisha, Ltd.) to have a solid concentration of 48%.

### Example 7

Example 6 was repeated to produce a sheet of coated paper except that the adhesive components of the second coating mixture used in example 6 were replaced by styrene-butadien copolymer latex (trade name: T-2629M, Acrylonitrile monomer content: 17 mass %, Average particle diameter: 125 nm, JSR Corporation).

### Example 8

Example 6 was repeated to produce a sheet of coated paper except that the coating amount of the undercoat was changed to 10 g/m² per side surface after the coated material was dried.

### Example 9

Example 6 was repeated to produce a sheet of coated paper except that the fine quality base paper was replaced by one having a bulk density of 0.67 g/cm³ (basis weight: 70.0 g/m²).

### Comparative Example 1

Example 2 was repeated to produce a sheet of coated paper except that all the pigment components of the first coating mixture used in example 2 were replaced by those consisting of ground calcium carbonate having an average particle diameter of 1.3 μm (trade name: Hydrocarb 60, Bihoku Funka Kogyo Co., Ltd.).

### Comparative Example 2

Example 1 was repeated to produce a sheet of coated paper except that all the pigment components of the first coating mixture used in example 1 were replaced by those consisting of ground calcium carbonate having an average particle diameter of 1.3 μm (trade name: Hydrocarb 60, Bihoku Funka Kogyo Co., Ltd.).

### Comparative Example 3

Example 2 was repeated to produce a sheet of coated paper except that the pigment components of the first coating mixture used in example 2 were replaced by those consisting of 90% of ground calcium carbonate having an average particle diameter of 2.1 μm (trade name: B21, Oji Paper Co., Ltd. Yonego Factory), and 10% of satin white having an average particle diameter of 1.0 μm (trade name: Satin White B, Shiraishi Kogyo Kaisha, Ltd.).

### Comparative Example 4

### Preparation of Coarse Particle Satin White Pigment Slurry

90 kg (90 liter) water was poured into a 250 liter Cowles dissolver. 10.0 kg massive quick lime (CaO, Ashidachi lime Co., Ltd.) that had not been classification-processed, which means that it included particles whose diameter is 1-4 cm, were added to this water. Next, while stirring, the liquid temperature was increased to dissolve the lime and maintained at a range of 85-95° C. for an hour, and then cooled down to 30° C. Then, while stirring more vigorously, 58.3 kg aqueous solution of aluminum sulfates {Al₂(SO₄)₃.18H₂O 25 kg dissolved in water 50 kg (50 liter)} was gradually added at a rate of 1 kg/min to obtain satin white suspension.

This suspension was expressed by a filter press to obtain a cake-like satin white having a solid concentration of 32%. Three parts of sodium polycarboxylic acid (trade name: AronT-40, Toagosei Co., Ltd.) and water were added based on the thus obtained satin white 100 parts (in terms of solid matter) to have a solid concentration of 20%. Then, the mixture was passed through a sand grinder to obtain a dispersion liquid of satin white and screen-mesh processed with 150 meshes to produce satin white pigment slurry having a solid concentration of 20%. The average particle diameter of satin white obtained from this pigment slurry was 3.0 μm pursuant to radiolucent particle size distribution measurement.

Example 2 was repeated to produce a sheet of coated paper except that the pigment components of the first coating mixture used in example 2 were replaced by those consisting of 90% ground calcium carbonate having an average particle diameter of 1.3 μm (trade name: Hydrocarb 60, Bihoku Funka Kogyo Co., Ltd.), and 10% coarse particle satin white obtained as above.

### Example 10

Example 2 was repeated to produce a sheet of coated paper except that the pigment components of the second coating mixture used in example 2 were replaced by those consisting of 10% of fine kaolin having an average particle diameter of 0.4 μm (trade name: Kaogloss, Huber Inc. U.S.A.), 80% of ground calcium carbonate having an average particle diameter of 0.8 μm (trade name: Hydrocarb 90, Bihoku Funka Kogyo Co., Ltd.), and 10% of satin white having an average particle diameter of 1.0 μm (trade name: Satin White B, Shiraishi Kogyo Kaisha, Ltd.).

### Example 11

Example 10 was repeated to produce a sheet of coated paper except that the adhesive components of the second coating mixture used in example 10 were replaced by styrene-butadien copolymer latex (trade name: T-2629M, Acrylonitrile monomer content: 17 mass %, Average particle diameter: 125 nm, JSR Corporation).

### Comparative Example 5

Example 10 was repeated to produce a sheet of coated paper except that the all pigment components of the first coating mixture used in example 10 were replaced by those consisting of ground calcium carbonate having an average particle diameter of 1.3 μm (trade name: Hydrocarb 60, Bihoku Funka Kogyo Co., Ltd.).

### Quality Evaluation of Coated Paper for Printing

The quality of each coated paper for printing obtained by examples 1-11 and comparative examples 1-5 was evaluated according to the following items. Evaluation was carried out under the condition of 50 RH % and at temperature 23° C. unless otherwise specified. The results are shown in tables 1(a)-1(c).

### PPS Smoothness of Coated Paper

Smoothness measurement has been performed five times by Parker Print Surf (PPS) surface smoothness tester (type of machine: MODEL M-569, MESSMER BUCHEL, United Kingdom) with a backing disk of soft rubber and clamp pressure of 0.98 MPa to determine an average smoothness. Smoothness measurement was performed after an undercoat was applied, after an outermost coating layer was applied, and after calender-finishing, respectively.

### Surface Smoothness

A coating surface was visually observed after final calender-processing to evaluate smoothness in accordance with the following four grades:

⊚): Particularly excellent in smoothness
◯: Excellent in smoothness
Δ: Slightly deficient in smoothness
x: Deficient in smoothness

### Streak on Coating Surface

A coating surface of an outermost coating layer of each coated paper was visually observed after final calender-processing to detect any existence of streaks.

◯: No streak was observed
Δ: Streak was observed

### White Paper Glossiness

Glossiness of each coated paper was measured by a glossiness measuring apparatus (Model: GM-26D, Murakami Color Research Laboratory Co., Ltd.) in accordance with TAPPI Test Method: 480 om-92 (TAPPI Test Method T 480 om-92) before and after calender-processing.

### Printability (Ink-Setting Property and Printing Smoothness)

Each coated paper was printed with 0.1 cc printing ink (trade name: Values-G, Black, S-type, Dainippon Ink and Chemicals Inc.) by using an RI printer. The ink transferred surface of a coated paper was visually observed to evaluate the printability of the paper regarding transferred ink concentration (ink-setting property) and uniformity of concentration (printing smoothness) in accordance with the following four grades:

⊚: Particularly excellent in printability
◯: Excellent in printability
Δ: Slightly deficient in printability
x: Deficient in printability

### Printing Glossiness

Each coated paper was printed with 0.7 cc printing ink (trade name: Values-G, Black, S-type, Dainippon Ink and Chemicals Inc.), and printed papers were ventilation-dried for 24 hours. Then, the glossiness of the surface of each coated paper was measured at 60 degrees pursuant to JIS Z8741-1997.

### Bulk Density

A bulk density of a base paper and a coated paper for printing after calender-processing was measured in accordance with the prescription of

TABLE 1(a)

| | | Example | Example | Example | Example | Example | Example | Example |
|---|---|---|---|---|---|---|---|---|
| | | 1 | 2 | 3 | 4 | 5 | 6 | 7 |
| Coating | Outermost Layer (Values are parts of mixture) | | | | | | | |
| Mixture | Kaolin | 80 | 80 | 80 | 80 | 80 | 80 | 80 |
| | GCC | 20 | 10 | 10 | 10 | 10 | 10 | 10 |
| | Satin White | — | 10 | 10 | 10 | 10 | 10 | 10 |
| | Starch | 2 | 2 | 2 | 2 | 2 | 2 | 2 |
| | Latex (PA2323) | 12 | 12 | 12 | 12 | 12 | 12 | — |
| | Latex(T2629M) | — | — | — | — | — | — | 12 |
| | Undercoat (Values are parts of mixture) | | | | | | | |
| | Satin White | 10 | 10 | 10 | 10 | 30 | 10 | 10 |
| | Satin White (Coarse) | — | — | — | — | — | — | — |
| | GCC | 90 | 90 | 90 | 90 | 70 | — | — |
| | GCC (Coarse) | — | — | — | — | — | — | — |
| | GCC (Fine) | — | — | — | — | — | 90 | 90 |
| | Starch | 2 | 2 | 6 | 0.1 | 2 | 2 | 2 |
| | Latex | 10 | 10 | 8 | 11 | 10 | 10 | 10 |
| Coating | Outermost Layer (g/m²) | | | | | | | |
| Amount | | 9 | 9 | 9 | 9 | 9 | 9 | 9 |
| | Undercoat (g/m²) | | | | | | | |
| | | 8 | 8 | 8 | 8 | 8 | 8 | 8 |
| PPS | After undercoating (Mm) | | | | | | | |
| Smoothness | | 3.16 | 3.16 | 3.38 | 2.84 | 2.63 | 2.44 | 2.52 |
| | After Outermost layer was provided (Mm) | | | | | | | |
| | | 1.05 | 0.98 | 1.10 | 0.95 | 0.93 | 0.93 | 0.96 |
| | After calender processing (Mm) | | | | | | | |
| | | 0.87 | 0.82 | 0.96 | 0.80 | 0.78 | 0.75 | 0.76 |
| Streak | Existence of Streak | ◯ | ◯ | ◯ | ◯ | ◯ | ◯ | ◯ |
| | White Paper Glossiness before Calendering (%) | | | | | | | |
| | | 55 | 58 | 54 | 59 | 60 | 61 | 61 |
| | White paper Glossiness after calendering (%) | | | | | | | |
| | | 67 | 71 | 66 | 72 | 73 | 73 | 73 |
| | Surface Smoothness | | | | | | | |
| | Visual Evaluation | ◯ | ◯ | ◯ | ⊚ | ⊚ | ⊚ | ⊚ |
| | Printability | | | | | | | |
| | Visual Evaluation | ◯ | ◯ | ◯ | ⊚ | ⊚ | ⊚ | ⊚ |
| | Printing Glossiness (%) | | | | | | | |
| | | 69 | 71 | 72 | 73 | 73 | 73 | 69 |
| | Bulk Density (g/cm³) | | | | | | | |
| | | 1.04 | 1.03 | 1.03 | 1.03 | 1.03 | 1.03 | 1.03 |
| Base Paper | Bulk Density (g/cm³) | | | | | | | |
| | | 0.73 | 0.73 | 0.73 | 0.73 | 0.73 | 0.73 | 0.73 |

TABLE 2(b)

| | | Example | Example | Comparative | Comparative | Comparative | Comparative |
|---|---|---|---|---|---|---|---|
| | | 8 | 9 | Example 1 | Example 2 | Example 3 | Example 4 |
| Coating | Outermost Layer (Values are parts of mixture) | | | | | | |
| Mixture | Kaolin | 80 | 80 | 80 | 80 | 80 | 80 |
| | GCC | 10 | 10 | 10 | 20 | 10 | 10 |
| | Satin White | 10 | 10 | 10 | | 10 | 10 |
| | Starch | 2 | 2 | 2 | 2 | 2 | 2 |
| | Latex (PA2323) | 12 | 12 | 12 | 12 | 12 | 12 |
| | Latex (T2629M) | — | — | — | — | — | — |
| | Undercoat (Values are parts of mixture) | | | | | | |
| | Satin White | 10 | 10 | — | — | 10 | — |
| | Satin White(Coarse) | — | — | — | — | — | 10 |
| | GCC | — | — | 100 | 100 | — | 90 |
| | GCC (Coarse) | — | — | — | — | 90 | — |
| | GCC (Fine) | 90 | 90 | — | — | — | — |
| | Starch | 2 | 2 | 2 | 2 | 2 | 2 |
| | Latex | 10 | 10 | 10 | 10 | 10 | 10 |
| Coating | Outermost Layer (g/m²) | | | | | | |
| Amount | | 9 | 9 | 9 | 9 | 9 | 9 |
| | Undercoat (g/m²) | | | | | | |
| | | 10 | 8 | 8 | 8 | 8 | 8 |
| PPS | After undercoating (Mm) | | | | | | |
| Smoothness | | 1.87 | 2.87 | 3.67 | 3.67 | 4.26 | 3.73 |
| | After Outermost layer was provided (Mm) | | | | | | |
| | | 0.83 | 1.03 | 1.18 | 1.32 | 1.60 | 1.24 |
| | After calender processing (μm) | | | | | | |
| | | 0.64 | 0.85 | 1.09 | 1.22 | 1.38 | 1.15 |
| Streak | Existence of Streak | Δ | ◯ | ◯ | ◯ | ◯ | ◯ |
| | White Paper Glossiness before Calendering (%) | | | | | | |
| | | 62 | 57 | 53 | 50 | 48 | 47 |
| | White paper Glossiness after calendering (%) | | | | | | |
| | | 72 | 68 | 63 | 59 | 59 | 58 |
| | Surface Smoothness | | | | | | |
| | Visual Evaluation | ⊚ | ◯ | Δ | Δ | X | Δ |
| | Printability | | | | | | |
| | Visual Evaluation | ⊚ | ◯ | Δ | Δ | X | Δ |
| | Printing Glossiness (%) | | | | | | |
| | | 71 | 69 | 67 | 65 | 64 | 65 |
| | Bulk Density (g/cm³) | | | | | | |
| | | 1.04 | 0.97 | 1.03 | 1.04 | 1.04 | 1.03 |
| Base | Bulk Density (g/cm³) | | | | | | |
| Paper | | 0.73 | 0.67 | 0.73 | 0.73 | 0.73 | 0.73 |

TABLE 3(c)

| | | | | Comparative |
|---|---|---|---|---|
| | | Example 10 | Example 11 | Example 5 |
| Coating Mixture | Outermost Layer (Values are | | | |
| | parts of mixture) | | | |
| | Kaolin | 10 | 10 | 10 |
| | GCC | 80 | 80 | 80 |
| | Satin White | 10 | 10 | 10 |
| | Starch | 2 | 2 | 2 |
| | Latex (PA2323) | 12 | — | 12 |
| | Latex (T2629M) | — | 12 | — |
| | Undercoat (Values are parts | | | |
| | of mixture) | | | |
| | Satin White | 10 | 10 | — |
| | Satin White (Coarse) | — | — | — |
| | GCC | 90 | 90 | 100 |
| | GCC (Coarse) | — | — | — |
| | GCC (Fine) | — | — | — |
| | Starch | 2 | 2 | 2 |
| | Latex | 10 | 10 | 10 |
| Coating Amount | Outermost Layer (g/m²) | 9 | 9 | 9 |
| | Undercoat (g/m²) | 8 | 8 | 8 |
| PPS Smoothness | After undercoating (Mm) | 3.16 | 3.20 | 3.67 |
| | After Outermost layer was | 1.06 | 1.12 | 1.60 |
| | provided (Mm) | | | |
| | After calender processing (Mm) | 0.89 | 0.90 | 1.22 |
| Streak | Existence of Streak | ◯ | ◯ | ◯ |
| | White Paper Glossiness before | 35 | 35 | 31 |
| | Calendering (%) | | | |
| | White paper Glossiness after | 43 | 43 | 42 |
| | calendering (%) | | | |
| | Surface Smoothness | ◯ | ◯ | Δ |
| | Visual Evaluation | | | |
| | Printability | ◯ | ◯ | Δ |
| | Visual Evaluation | | | |
| | Printing Glossiness (%) | 68 | 64 | 64 |
| | Bulk Density (g/cm³) | 1.03 | 1.03 | 1.04 |
| Base Paper | Bulk Density (g/cm³) | 0.73 | 0.73 | 0.73 |

What is claimed is:

1. A coated paper for printing having a bulk density of 1.05 g/cm³ or less and two or more coating layers mainly composed of white pigments and adhesives formed on at least one side of a base paper which has a bulk density of 0.75 g/cm³ or less, co
wherein pigments of an undercoat in contact with an outermost coating layer comprises satin white of 1-30 mass % whose average particle diameter is within a range of 0.1-1.3 μm measured pursuant to radiolucent particle size distribution measurement and other white pigments of 70-99 mass %, wherein the amount of the adhesives of the undercoat is within a range of 10-20 mass % based on 100 mass parts of pigment components.

2. A coated paper for printing as defined in claim 1, wherein adhesive components of said undercoat comprise dispersant type adhesives whose particle diameter is 120 nm or less.

3. A coated paper for printing as defined in claim 2, wherein adhesive components of said undercoat comprise water soluble adhesives and dispersant type adhesives, wherein the amount of water soluble adhesives is 7 mass parts or less based on 100 parts of pigment components contained in the undercoat.

4. A coated paper for printing as defined in claim 1, wherein pigment components of said outermost coating layer comprise white pigments having an average particle diameter within a range of 0.1-1.3 μm according to radiolucent particle size distribution measurement, wherein the amount of the adhesive components of the outermost layer is within a range of 10-20 mass parts based on 100 mass parts of the white pigments.

5. A coated paper for printing as defined in claim 4, wherein 1-30 mass % of the white pigments contained in the outermost coating layer is satin white.

6. A coated paper for printing as defined in claim 1, wherein adhesive components of the outermost coating layer comprise water soluble adhesives and dispersant type adhesives, wherein the amount of water soluble adhesives is 4 mass parts or less based on 100 mass parts of the pigment components contained in the outermost layer.

7. A method of producing a coated paper for printing comprising a step of:
applying a first coating mixture containing pigment components composed of satin white having an average diameter of 0.1-1.3 μm according to radiolucent particle size distribution measurement in an amount of 1-30 mass % and other white pigments in an amount of 70-99 mass %, and adhesives in an amount of 10-20 mass parts based on 100 mass parts of the pigment components on at least one side of a base paper whose bulk density is 0.75 g/cm³ or less, dried to form an undercoat;
applying a second coating mixture containing pigment components having an average diameter of 0.1-1.3 μm according to radiolucent particle size distribution measurement, and adhesives in an amount of 10-20 mass parts based on 100 mass parts of the pigment components on a surface of the undercoat dried to form an outermost coating layer;
and calender-processing the thus obtained coated paper under mild conditions.

8. The method defined in claim 7, wherein said first coating mixture is blade-coated on a base paper, wherein PPS smoothness of the undercoat is maintained in a range of 2.0-3.5 μm.
